(19) United States
(12) Patent Application Publication
(10) Pub. No.: US 2013/0273629 A1
(43) Pub. Date: Oct. 17, 2013

(54) Method for treating vegetable, fruit and garden waste

(71) Applicants: Gerrit Jacobus De Jong, Huizen (NL); Willem Elsinga, Ermelo (NL)

(72) Inventors: Gerrit Jacobus De Jong, Huizen (NL); Willem Elsinga, Ermelo (NL)

(73) Assignee: Axpo Kompogas AG, Glattbrugg (CH)

(21) Appl. No.: 13/993,569

(22) PCT Filed: Dec. 14, 2011
(86) PCT No.: PCT/EP2011/072779

§ 371 Date: Jun. 12, 2013

(30) Foreign Application Priority Data
Dec. 14, 2010 (EP) 10194940.2

(51) Int. Cl. B09B 3/00

(52) U.S. Cl. CPC B09B 3/00
USPC 435/170; 435/267; 435/290.2

(57) ABSTRACT

The present invention relates to a method for treating vegetable, fruit and garden waste, comprising the steps of: a) fermenting vegetable, fruit and garden waste, b) mixing the at least partially fermented waste from step a) with compost, c) composting the thus obtained mixture to obtain compost, wherein the percentage dry matter by weight of the mixture obtained in step b) is at least 35. Furthermore, the present invention relates to a method of providing a greenhouse with carbon dioxide and/or heat. Also, the present invention relates to a method of composting fermented vegetable, fruit and garden waste. The present invention furthermore relates to a waste treatment facility for the treatment of vegetable, fruit and garden waste.

The present invention relates to a method and waste treatment facility for treating vegetable, fruit and garden (VFG) waste. Furthermore, the invention relates to a method of providing a greenhouse with carbon dioxide and/or heat obtainable from fermenting and composting vegetable, fruit and garden waste.

At present, vegetable, fruit and garden waste, herein VFG waste, can be recycled into useful products by at least two distinct industrially applied biological degradation processes, being anaerobic fermentation and composting.

Anaerobic fermentation as used in the organic waste-treatment industry is a biological process mediated by micro-organisms, primarily bacteria, which is used to produce biogas as a source of energy. This anaerobic fermentation process comprises several stages of decomposition of organic matter including hydrolysis, acidogenesis, acetogenesis and methanogenesis. During this fermentation process, biogas, primarily methane and carbon dioxide, is produced as well as a residue, termed digestate. The fermentation process can, depending on the temperature at which fermentation takes place, be divided into thermophylic, mesophylic and psychrophylic fermentation.

The second process suitable for treating VFG waste is composting which is a degradation process by which organic matter is partly decomposed into smaller organic molecules. On an industrial scale, this aerobic process is performed by micro-organisms, primarily bacteria and fungi. During the course of this process heat, water, carbon dioxide and a rather dry residue, termed compost is obtained.

Although both processes are applied in the waste processing industry as a means to treat organic waste, the actual implementation, application and/or optimisation on an industrial scale of the two technologies as a combination cannot be accomplished in a straight-forward manner. There are many aspects that need to be considered when attempting to optimize the treatment of VFG waste in order to achieve an economically and industrial applicable technology which is suitable for the treatment of organic waste. Such aspects to consider include the type, size, amount or nature of the organic waste which is offered or supplied to the treatment facility. Moreover, seasonal changes in the type, size, amount and nature of organic waste which is supplied add another layer of complexity which treatment facilities face. Furthermore, fermentation and composting are naturally occurring processes, as such applied on a very heterogeneous and variable source of solid organic waste which makes it unclear at times how certain aspects of the treatment process can be optimised. Consequently, it is technically challenging to design a treatment facility which allows year-round predictable processing of a highly variable and seasonally fluctuating supply of raw organic matter which can be operated at economically competitive rates.

Another problem which the VFG waste treatment industry currently faces is that during the treatment of said municipal organic waste, especially due the pre-treatment of digestate which is required to make the digestate suitable for composting, an undesired wet fraction is obtained. The disposal of this wet fraction is costly and generally restricted by local jurisdiction. Furthermore, the presently practiced pre-treatment of digestate brings along high investments, high running costs and high maintenance costs which are all critical points of concern in this sensitive, vulnerable process for which downtime needs to be avoided.

Therefore, it is an object of the present invention to provide a method for treating vegetable, fruit and garden waste. Furthermore, an object of the invention is to provide a treatment facility for the treatment of vegetable, fruit and garden waste. Also, an object of the present invention is to provide a method for providing a greenhouse with carbon dioxide and/or heat and a method for composting vegetable, fruit and garden waste.

The above object, amongst others, is achieved by a method and installation as defined in the appended claims.

Specifically, the present invention relates to a method for treating vegetable, fruit and garden waste, comprising the steps of:

a) fermenting vegetable, fruit and garden waste,
b) mixing compost with the, at least partially, fermented waste of step a), optionally further including non-fermented VFG waste,
c) composting the thus obtained mixture to obtain compost.

Most preferably, the mixture obtained in step b), comprising compost and/or VFG waste comprises, which is obtained prior to the composting thereof in step c), comprises from 35% to 55%, preferably from 40% to 50%, more preferably from 42% to 48%, most preferably from 44% to 46% dry matter by weight of said mixture. At these ranges of dry matter, the composting of said mixture proceeds in a suitable manner resulting in the production of compost, heat and water.

Technically however, there appears to be no upper limit to the percentage dry weight of the mixture. Therefore, in a more preferred embodiment, mixtures comprising compost and/or VFG waste comprising, prior to composting, of at least 35%, preferably at least 40%, more preferably at least 42%, most preferably at least 44% dry matter by weight of said mixture are used for the composting in step c). An advantage of using the herein disclosed ranges or lower limits of dry matter is that the mixtures can comprise higher amounts of digestate, in particular when the fraction compost and/or VFG waste comprises a high dry matter content. In this way, more digestate can be composted by the same composting facility, thus increasing the overall throughput of the composting process.

VFG waste herein comprises organic, biodegradable waste from domestic, municipal and/or industrial origin, such as from the food industry, catering industry, industrial scale greenhouses, but not excluding privately-owned greenhouses. VGF waste herein includes fruits, vegetables, kitchen waste, leftovers from meals, coffee grounds, paper, cardboard, eggshells, garden waste such as plants, flowers, wood, leaves, grass, animal faeces, or other animal-derived waste such as meat, animal fat and the like. Although the VFG waste comprises primarily of organic matter, it generally also comprises, to a lesser extent, inorganic matter, such as soil, sand, stones and the like.

VFG waste herein also means VFG waste which is source-separated or non-source-separated. VFG waste not separated at the source is generally referred to as Organic Wet Fraction, or OWF. Even though differences may exist between the presence of pollutants in compost derived from source-separated or non-source-separated VFG waste (or OWF), the method according to the present invention provides a solution to the treatment of VFG waste in general. Consequently, VFG waste herein is meant to include OWF.

Production of compost derived from source-seperated VFG waste has an advantage for the organic waste treatment industry as this compost is of high quality and can readily be used in applications like agriculture. Separation of organic waste after collection at the source results in organic waste which can readily be composted, but compost derived from such waste is generally polluted with compounds such as heavy metals or other impurities, resulting in compost of lower quality. Generally such compost needs to be disposed of, contained or dumped, at high costs, in such a manner that it is not exposed to the environment. Irrespective of such differences, any VFG waste can be treated and composted according to the present invention.

The term “composting” herein is used in its arts recognized meaning, i.e. allowing organic waste to decompose by aeration under ambient to sufficiently high temperatures (up to 70° C.) to obtain a compost. The term “at least partially fermented VFG waste” herein means VFG waste which has been fermented to the extent that biogas is formed. This term also includes digestate. The term “digestate” herein means material remaining after the anaerobic fermentation of VGF waste. In such anaerobic fermentation, two main products are obtained being this digestate and biogas. Furthermore, a digestate as meant herein is characterized in that it may comprise any amount of dry matter of between 15 to 40, preferably 20 to 30 percent by weight of the digestate.

An advantage of the present invention is that it is now possible to compost at least partially fermented VFG waste or digestate without the requirement to pre-treat the at least partially fermented VFG waste or digestate prior to composting thereof.

Present day treatment of VFG waste comprising fermentation and subsequent composting, generally results in the formation of a fermentation-derived digestate which is not suitable yet for composting thereof. In order for this digestate to become suitable for composting, it needs to be pre-treated such that a dry fraction is obtained which is suitable for subsequent composting thereof. Such pre-treatment, as practiced according to the state of the art, is generally achieved by applying pressure on the digestate, for example by using a screw press, or by gravitational force, as a consequence of which water drains from the digestate resulting in the provision of what is commonly termed as a dry fraction and a wet fraction. This dry fraction is suitable for composting. The wet fraction is a highly undesirable by-product, the disposal of which is a major debit for the organic waste treatment industry. Besides being costly, disposal of this wet fraction, e.g. as fertilizer or landfiller, is not always allowed as local prevailing jurisdiction may prevent or restrict such disposal.

As the at least partially fermented VGF waste or digestate obtained from fermentation of VFG waste can be composted without separating it into a dry and a wet fraction, herein meaning non-fractioned digestate, the method according to the present invention is more cost-effective and efficient than methods which do require such pre-treatment of digestate.

Another advantage of the present invention is that in essence only biogas from the fermentation step, and compost, heat and water is obtained by subsequent steps in the treatment of VFG waste. The present invention thus allows for the treatment of VFG waste without the generation of from digestate-derived wet fraction. As the method according to the present invention only results in the production of heat, water, compost and biogas, problems related to the disposal of digestate-derived wet fraction are prevented.

In a preferred embodiment, the at least partially fermented waste according to step b) is a digestate obtained from fermenting VFG waste or a combination of such digestate with at least partially fermented VFG waste. In practice, the at least partially fermented VGF waste of step a) is produced in the same processing plant as where the composting of step c) is performed. However, it is also possible to combine the at least partially fermented VGF waste with compost from any other processing plant.

According to the present invention, the fermentation of VFG waste will proceed such that considerable amounts of biogas (primarily methane and CO₂) are produced and that a fermented residue, or digestate, is produced. Preferably, such a digestate as meant herein is a residue which is derived from the, in essence, complete fermentation of VFG waste. Such fermentation is preferably thermophylic fermentation but can also be mesophylic or psychrophylic fermentation. Suitable thermophylic fermentation conditions include, but are not limited to: continuous and/or evenly spread, batch-wise feeding of the fermentation tank, or digester; maintaining the fermentation process at a temperature of 50-60° C., preferably approximately 55° C.; maintaining the humidity of the content of the fermentation tank between 60-80%, preferably approximately 70%; and fermenting for a period of between 8 to 30 days, preferably approximately 14 days.

In yet another preferred embodiment, the weight of digestate and/or the at least partially fermented VFG waste divided by the weight of compost and/or vegetable, fruit and garden waste of said mixture is, prior to composting, between 0.3 to 2.0, preferably 0.4 to 1.5, more preferably 0.5 to 1.5, most preferably 0.6 to 1.2 or about 0.7. Composting of mixtures comprising digestate, the at least partially fermented VFG waste, compost and/or vegetable, fruit and garden waste at these ranges allow for mixtures to be processed comprising higher amounts of digestate, in particular when the fraction compost and/or VFG waste comprises a high dry matter content. In this way, more digestate can be composted by the same composting facility, thus increasing the overall throughput of the composting process.

Another advantage of the present invention is the flexibility of the treatment process which allows varying of the amounts and nature of the VFG waste as supplied to the waste treatment facility. For example, the mixture which can be composted in step c) can comprise a wide range of percentages dry matter of the organic material to be composted. This allows to compost digestate without separating it into a wet and dry fraction. It also allows flexibility in the amounts of compost and/or VFG waste to be added to the fermented waste of step a) for composting.

Another advantage of this flexibility is that the treatment process, and thereby the treatment facility, as a whole can deal with seasonal changes in the supply of VFG waste. When the fermentation installation, or digester, would be used at maximal capacity, the system allows surplus VFG waste to be composted without prior fermentation. This flexibility also allows for the implementation of a fermentation installation which is designed to process the lowest seasonal supply of VFG waste instead of the highest seasonal supply thereof. As a fermentation installation is one of most expensive parts of such a treatment facility, it is advantageous to use the method according the present invention which provides such flexibility.

In yet another preferred embodiment, the mixture of step c) is mixed prior to composting thereof. A suitable mixing means for mixing thereof is a compost mixer. Mixing of the compost and/or vegetable, fruit and garden waste with the at least partially fermented waste increases the homogeneity of the mixture before composting. Mixing thus supports an evenly proceeding and homogenous composting process. In the test as described in Example 2 it was surprisingly found that by mixing, the bulk density of the mixture was increased from about 700 kg/m³ to about 850 kg/m³. This increases the available space and the capacity of the composting facility with at least 20%.

In a preferred embodiment, the composting of the mixture of step c) is for a period of 4 to 40 days, preferably 14-16 days.

In yet another preferred embodiment, the compost from step c) is added in step b). An advantage of using the compost of step c) in step b) is that compost from step c) is allowed to compost further leading to a higher stability of the resulting compost and to optimal use of the available material in the treatment facility.

As the processing of VFG waste preferably occurs in a single waste treatment facility, the at least partially fermented waste or digestate according to step b) is preferably fermented VFG waste from step a).

In yet another preferred embodiment, the at least partially fermented waste or digestate comprises 20 to 38, preferably 24 to 34, more preferably 26 to 32 percent by weight dry matter.

In yet another preferred embodiment the compost comprises 40 to 90, preferably 50 to 80, more preferably 60 to 70 percent by weight dry matter. Said compost can be the compost added in step b) and/or the compost from step c).

In yet another preferred embodiment, the VFG waste comprises 25 to 60, preferably 30 to 50 percent by weight dry matter.

It will be clear to the skilled person which ratios of the at least partially fermented waste or digestate, the compost or the VFG waste can be used in step b) of the present invention to obtain a sufficiently dry mixture which can be composted in step c).

In yet another preferred embodiment, the VFG waste of step b) is in essence untreated or unfermented VFG waste. Untreated or unfermented VGF waste herein means VFG waste which has not been subjected to an industrial fermentation and/or composting process. As fermentation and composting are naturally occurring processes and as the VFG waste is generally disposed of several weeks prior to collection at the waste treatment facility, the VFG waste may show signs of fermentation or perhaps composting. Despite such signs, such VFG waste is considered herein as untreated, unfermented VFG waste.

In yet another preferred embodiment, the VFG waste of step a) is sieved and/or shredded prior to fermentation thereof. Sieving and/or shredding of VFG waste has the advantage that in essence the entire flow of VFG waste can be treated and/or handled by the VFG waste treatment facility. Sieving of VFG waste has an additional advantage that the surface area of the fraction which is to be fermented is sufficient large to enable a suitable and in essence complete fermentation of the fermentable matter thereof.

In yet another preferred embodiment, the compost from step c) is size fractioned, preferably by sieving, into size fractions of <15 mm, 15-40 mm and >40 mm. Generally, fractions of <15 mm are considered as the end-product of the treatment of VFG and suitable for being marketed as compost. When such compost would be unsuitable for marketing, for example as there would be too much toxic compounds or too many impurities comprised by the compost, such compost needs to be disposed of in such a way as to prevent it from being exposed to the environment.

In yet another preferred embodiment, the non-fractioned compost is added to the at least partially fermented waste or digestate of step b). Even though from a financial point of view non-sieved compost may be the preferred choice of compost for circulation thereof, sieved compost can also be used for circulation. Circulation of non-fractioned, but also sieved or fractioned compost, is advantageous as such compost can be composted more efficiently and effectively. Additionally or alternatively, the digestate can also be sieved prior to mixing with compost and/or VFG waste.

It is preferred to use non-fractioned compost or compost of larger size (>15 mm) for mixing with digestate. Such larger sized compost improves the aeration of the mixture to be composted. Also, larger sized matter may compost into smaller parts by (re)circulation thereof into the composting treatment.

In another suitable embodiment, composting the mixture of step c) is by aeration with air of ambient temperature to 70° C., preferably ambient temperature to 65° C. Additionally or alternatively, such air may be of ambient temperature prior to aeration and become heated to 30 to 70° C., preferably 40 to 65° C. by its use as aeration means. Additionally or alternatively, such air is of ambient temperature prior to aeration and becomes heated to from 30 to 70° C., preferably 40 to 65° C., as a consequence of the use thereof in aeration of the compost. Such air used for aeration can be heated by use of a heat exchanger using heat from the air before passage thereof through the bio-filter.

In yet another preferred embodiment, the fermenting the VFG waste of step a) is thermophylic fermentation. Mesophylic and psychrophylic fermentation may also be suitable for use according to the invention. Thermophylic fermentation proceeds faster than mesophylic or psychrophylic fermentation.

In yet another preferred embodiment, CO₂, produced in the fermentation of step a), is collected. Subsequently, the CO₂ is preferably supplied to a greenhouse. Besides collection of CO₂ for supply to a greenhouse, CO₂ may be supplied to any interested third party. An advantage of supplying CO₂ to a greenhouse is the generation of a short-cycle of CO₂. Short-cycle CO₂ means that CO₂ which was fixed by plants, is released by the biological fermentation after which the released CO₂ is supplied to a greenhouse where it can be fixed by a plant again to sustain its growth and development.

Generally, in order to obtain purer or even high grade CO₂, it will be necessary to separate or upgrade the CO₂ from the biogas mixture which is collected during the fermentation process according to the invention. Next, the produced CO₂ can be further process or marketed.

In a final preferred embodiment, energy, preferably in the form of water of 30° C. to 60° C., produced in the composting of step c) is collected, preferably for supply to a greenhouse. However, the energy or heated water can be supplied to any third party. An advantage of supplying warm water to a greenhouse is that the energy derived from the composting process can be used to heat a greenhouse. Such a supply of energy contributes to an environmentally friendly operational management of a greenhouse or any other business. Such supply of heat to a greenhouse, or any other business or consumer, can be through a geothermal installation which allows supply of heat to the greenhouse upon demand.

Another aspect of the invention relates to a method for providing a greenhouse with carbon dioxide and/or heat comprising the steps of:

a) fermenting vegetable, fruit and garden waste to obtain biogas,
b) mixing compost and/or vegetable, fruit and garden waste with the at least partially fermented waste, wherein preferably a mixture is obtained having a dry weight percentage of at least 35,
c) composting the thus obtained mixture to obtain heat and compost,
d) separating CO₂ from the biogas from step a) and supplying the CO₂ to a greenhouse,
e) supplying heat produced in step c) to a greenhouse, preferably in the form of water of 30° C. to 60° C.

The method according to this aspect of the invention relating to the provision of a greenhouse with carbon dioxide and/or heat, can be combined with any of the embodiments according to the any of the aspects of treating VGF waste of the present invention according to the appended claims.

Another aspect of the invention relates to a method for composting vegetable, fruit and garden waste, comprising the steps of:

a) mixing at least partially fermented vegetable, fruit and garden waste with compost to obtain a mixture having a percentage dry matter by weight of at least 35,
b) composting the thus obtained mixture to obtain compost.

Again, the method according to this aspect of the invention relating to a method for composting vegetable, fruit and garden waste, can be combined with any of the embodiments according to any of the aspects of treating VGF waste of the present invention according to the appended claims.

A final aspect of the invention relates to a waste treatment facility for the treatment of vegetable, fruit and garden waste, comprising a fermentor (2) suitable for fermenting vegetable, fruit and garden waste into a digestate; means for adding, and optionally mixing of, compost and/or vegetable, fruit and garden waste to the digestate; means (3) for composting the mixture of digestate and compost and/or vegetable, fruit and garden waste.

Means for mixing digestate with compost and/or vegetable, fruit and garden waste can for example be a McLanahan mixer, but it will be clear for the skilled person that any suitable or comparable mixer will suffice.

In preferred embodiments, the waste treatment facility further comprises means (1) for shredding of vegetable, fruit and garden waste; and/or means (4) for sieving compost and/or vegetable, fruit and garden waste; and/or means (6) for receiving and/or storing biogas; and/or means (7) for receiving and/or storing CO₂, preferably upgraded CO₂, from the biogas; and/or means (8) for receiving and/or storing upgraded gas, preferably methane or upgraded methane, from the biogas; and/or means (5) for storing compost; and/or means (9) for treating humid, heated air derived from the composting means (3); means (10) for treating air derived from the means (9); means (11) for obtaining heat or energy from the humid, heated air from means (9), means (12) for receiving/storing water from means (9).

When operational, VFG waste is received by the waste treatment facility through means (20). VFG waste can be supplied to fermentor (2) by means (34) and/or pre-treated, such as shredded by means (1) and/or sieved into suitably smaller pieces by means (4) prior to fermentation. Additionally or alternatively, the VFG waste is composted by composting means (3) without prior fermentation (means 35). Additionally or alternatively, the VFG waste is pre-treated, such as shredded and/or sieved into suitably smaller pieces by means (1) and subsequently composted in composting means (3) without fermentation using means (50 or 52).

After fermentation by fermentor (2), biogas is collected (6) and optionally by via means (45) supplied to separating and/or upgrading means (13). Separated or upgraded CO₂ can be supplied via means (30) to collector (7) and supplied to a greenhouse via means (32). Also upgraded biogas, comprising methane, can also be obtained from means (6) and supplied, preferably as upgraded methane, via (31) to storage means (8) for storage and further supply via (33) to third parties, such as the transportation industry.

The fermentor (2) can be any fermentor, also termed digester or fermentation reactor, suitable for fermenting VFG waste. Such fermentor is preferably suitable for thermophylic fermentation, or any other suitable fermentation process.

Composting means (3) can be any suitable means for composting of VFG waste. Composting means (3) is provided with means for aeration thereof to ensure suitable composting can take place in means (3). Composting means (3) is a tunnel, chamber, room or space, preferably of elongated shape, with one or two openings at the ends for supply and removal of the content of the composting means. Preferably, composting means (3) is a tunnel which can be opened and closed from either side. The heated, humid air derived from composting means (3) is supplied by means (36) to means (9) which is intended for treatment of exhaust gas. Means (9) ensures warm water, air and cold water can be obtained. Via means (39) warm water is lead to a heat-exchanger (11) for exchange of heat or energy. Subsequently, heat or energy can be supplied to third parties by means (43), such as a greenhouse. Cooled water is supplied by means (40) back to means (9). Excess water can be supplied by means (41) to means (12) for treatment and final disposal via means (42) to third parties, and for example used for irrigation purposes. Ambient air can be supplied by means (46) to means (9) to obtain preheated air which can be used via means (47) in composting means (3). Exhaust gas can be supplied via (37) to treatment device (10), e.g. a biofilter, which treatment allows the discharge of air in the environment.

The present invention is further illustrated by the following figure and examples. These examples are not intended to limit the scope of the invention in any way.

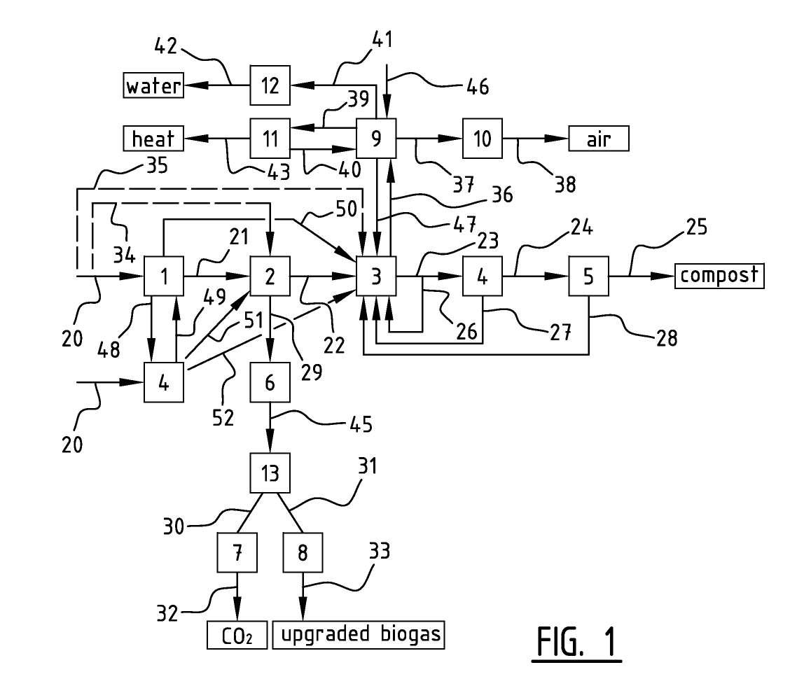

FIG. 1 shows a facility for treating vegetable, fruit and garden waste according to the present invention.

### EXAMPLE 1

Several mixtures of digestate, VFG waste and compost were made and examined for their suitability for composting thereof.

Digestate was mixed with VFG waste and compost. The amounts of the different components were determined, as well as the amount dry matter as a percentage by weigh and the amount of organic matter comprised by the dry matter as a percentage by weight. Tables 1 and 2 show the specifications of the different mixtures as used in the experimentation phase.

TABLE 1
Analysis of Mixture 1

| Mixture 1 | Digestate | VFG waste | Compost | Total |
|---|---|---|---|---|
| Amount (kg) | 17.370 | 4.937 | 11.213 | 33.520 |
| Mixture | 52 | 15 | 34 | 100 |
| composition (% w/w) | | | | |
| Dry Matter | 26 | 38 | 65 | 40 |
| content (% w/w) | | | | |
| Organic Matter of DM | 34 | 52 | 35 | 37 |
| (% w/w) | | | | |

TABLE 2
Analysis of Mixture 2

| Mixture 2 | Digestate | VFG waste | Compost | Total |
|---|---|---|---|---|
| Amount (kg) | 17.370 | 8.055 | 18.295 | 43.720 |
| Mixture | 40 | 18 | 42 | 100 |
| composition (% w/w) | | | | |
| Dry Matter | 26 | 38 | 65 | 44 |
| content (% w/w) | | | | |
| Organic Matter of DM | 34 | 52 | 35 | 37 |
| (% w/w) | | | | |

After visual inspection of the mixtures as obtained it was decided to compost mixture 2 as this mixture appeared to be more suitable for research purposes.

Composting of mixture 2 was for about 28 days in an open air windrow composting facility without additional turning and aerated by sucking air through the windrow by a perforated pipe under the windrow in which the pressure is maintained. Before the start the windrow was covered with a small layer of overscreen material from composting. The starting temperature of the compost, as measured inside a heap of compost, was about 30° C. The temperature increased to about 60 to 70 degrees within 1-4 days, indicating the composting proceeded in a suitable manner. The temperature was quite stable at around 70° C. for a period of roughly 10 days.

The compost as obtained from mixture 2 was sieved and analysed for dry matter content.

TABLE 3
Analysis of sieved fractions obtained from composting mixture 2.

| Fraction | DM (g/kg) | DM (% w/w) |
|---|---|---|
| <15 | 629 | 63 |
| 15-40 | 568 | 57 |
| >40 | 604 | 60 |

Results demonstrate that it is possible to treat VFG waste by a method using fermentation and composting according to the present invention. Moreover, the non-fractioned compost as obtained appeared to be very suitable for sieving and yielded compost of good quality.

### EXAMPLE 2

Two mixtures were obtained using a shovel to mix the mixture. After mixing with the shovel the mixtures were mixed with a compost mixer. Table 4 shows the results on bulk density:

TABLE 4
Bulk density of mixtures 1 and 2.

| | After mixing with | After mixing with |
|---|---|---|
| mixture | shovel | compost mixer |
| 1 | ±700 kg/m³ | 850-900 kg/m³ |
| 2 | 600-700 kg/m³ | ±850 kg/m³ |

Results demonstrate that in both cases mixing with a compost mixer increased the bulk density dramatically. Until now there is no clear explanation for that.

1. Method for treating vegetable, fruit and garden waste, comprising the steps of:
a) fermenting vegetable, fruit and garden waste;
b) mixing the at least partially fermented waste from step (a) with compost; and
c) composting the thus obtained mixture to obtain compost, wherein the percentage dry matter by weight of the mixture obtained in step (b) is at least 35.

2-14. (canceled)

15. A method according to claim 1, wherein the at least partially fermented waste is a digestate.

16. A method according to claim 1, wherein the at least partially fermented waste comprises 20% to 38% by weight dry matter.

17. A method according to claim 1, wherein the at least partially fermented waste comprises 24% to 34% by weight dry matter.

18. A method according to claim 1, wherein the at least partially fermented waste comprises 26% to 32% by weight dry matter.

19. A method according to claim 1, wherein the compost in step (b) or (c) comprises 40% to 90% by weight dry matter.

20. A method according to claim 1, wherein the compost in step (b) or (c) comprises 50% to 80% by weight dry matter.

21. A method according to claim 1, wherein the compost in step (b) or (c) comprises 60% to 70% by weight dry matter.

22. A method according to claim 1, wherein the vegetable, fruit and garden waste comprises 25% to 60% by weight dry matter.

23. A method according to claim 1, wherein the vegetable, fruit and garden waste comprises 30% to 50% by weight dry matter.

24. A method according to claim 1, wherein a ratio of the weight of the vegetable, fruit and garden waste divided by the weight of the compost from step (b) is between 0.3 and 2.0.

25. A method according to claim 1, wherein a ratio of the weight of the vegetable, fruit and garden waste divided by the weight of the compost from step (b) is between 0.4 and 1.5.

26. A method according to claim 1, wherein a ratio of the weight of the vegetable, fruit and garden waste divided by the weight of the compost from step (b) is between 0.5 and 1.5.

27. A method according to claim 1, wherein a ratio of the weight of the vegetable, fruit and garden waste divided by the weight of the compost from step (b) is between 0.6 and 1.2.

28. A method according to claim 1, wherein a ratio of the weight of the vegetable, fruit and garden waste divided by the weight of the compost from step (b) is about 0.7.

29. A method according to claim 1, wherein the step of fermenting is preceded by a step of sieving and/or shredding the vegetable, fruit and garden waste.

30. A method according to claim 1, wherein the compost from step (b) or step (c) is fractioned into size fractions of <15 mm.

31. A method according to claim 1, wherein the compost from step (b) or step (c) is fractioned into size fractions of 15-40 mm.

32. A method according to claim 1, wherein the compost from step (b) or step (c) is fractioned into size fractions of >40 mm.

33. A method according to claim 1, further comprising the step of adding non-fractioned compost to the at least partially fermented waste.

34. A method according to claim 1, wherein the step of composting includes composting by aeration with air at a temperature between ambient temperature and 70° C.

35. A method according to claim 1, wherein the step of composting includes composting by aeration with air at a temperature between ambient temperature and 65° C.

36. A method according to claim 1, wherein the step of fermenting produces a CO₂ component and wherein the step of composting produces a water component with a temperature between 30° C. and 60° C., the method further comprising the step of supplying at least one component selected from the group of CO₂, water and a combination thereof to a greenhouse.

37. Method for treating vegetable, fruit and garden waste, comprising the steps of:
a) fermenting vegetable, fruit and garden waste to obtain at least partially fermented waste and biogas;
b) mixing compost and/or vegetable, fruit and garden waste with the at least partially fermented waste such that a mixture is obtained having a dry weight percentage of at least 35%;
c) composting the mixture to obtain heat and compost; and
d) separating a CO₂ component from the biogas and supplying the CO₂ component and the heat to a greenhouse, wherein the heat is preferably in the form of water with a temperature of 30° C. to 60° C.

38. A waste treatment facility for the treatment of vegetable, fruit and garden waste, comprising:
a) a fermentor suitable for fermenting vegetable, fruit and garden waste into a digestate;
b) adding and mixing means for adding and optionally mixing compost and/or vegetable, fruit and garden waste with the digestate to obtain a mixture of digestate and compost and/or vegetable, fruit and garden waste, wherein the mixture includes at least 35% dry matter by weight; and
c) composting means for composting the mixture.

39. A waste treatment facility according to claim 38, further comprising means selected from the group consisting of:
d) shredding means for shredding of vegetable, fruit and garden waste;
e) sieving means for sieving compost and/or vegetable fruit and garden waste;
f) biogas receiving means for receiving and/or storing biogas;
g) biogas upgrading means for upgrading biogas;
h) CO₂ receiving means for receiving and/or storing CO₂ from the biogas;
i) upgraded biogas receiving means for receiving and/or storing upgraded biogas;
j) compost storing means for storing compost;
k) humid air treatment means for treating humid, heated air derived from the composting means;
l) means for treating air derived from the composting means;
m) energy extraction means for obtaining heat or energy from the humid, heated air obtained from the humid air treatment means,
n) water storage means for receiving/storing water from the humid air treatment means, and
o) a combination thereof.
